(19) United States
(12) Patent Application Publication
(10) Pub. No.: US 2023/0331037 A1
(43) Pub. Date: Oct. 19, 2023

(54) Cover Element Adapted for Attaching to a Vehicle Wheel

(71) Applicant: Bayerische Motoren Werke Aktiengesellschaft, Munchen (DE)

(72) Inventors: Markus DIX, Landshut (DE); Alwin MAIWALD, Muenchen (DE); Mike SEIDEL, Schoeneck (DE)

(21) Appl. No.: 18/026,861

(22) PCT Filed: Oct. 5, 2021
(86) PCT No.: PCT/EP2021/077399

§ 371 Date: Mar. 17, 2023

(30) Foreign Application Priority Data
Oct. 15, 2020 (DE) 10 2020 127 175.1

(51) Int. Cl. B60B 7/06; B60B 7/00

(52) U.S. Cl. CPC B60B 7/066; B60B 7/0033; B60B 2900/572

(57) ABSTRACT

A cover element is adapted for attaching to a vehicle wheel having a wheel hub, a wheel rim provided with a rim base for receiving a tire, and a central body connecting the wheel hub to the wheel rim. The cover element is configured in the shape of a circular disk in order to cover the central body, is distinguished in that the outer surface of the cover element is provided at least in regions with at least one bistable display element, such as an E-paper display element, with a display device, or is formed by at least one such display element. Electric control signals can be applied to the display device via a control unit.

### TECHNICAL FIELD

The invention relates to a cover element adapted for attaching to a vehicle wheel. It also relates to a vehicle wheel having at least one such cover element, and to vehicle having at least one such vehicle wheel.

### BACKGROUND AND SUMMARY

Particularly in the case of electric vehicles, closed wheels, in which the outer surface of the vehicle wheel is covered or at least partially closed radially inside the wheel rim, are used for aerodynamic reasons. Plastic covers that are glued, clipped or screwed into the metallic main body of the vehicle wheel are normally used for this purpose. On some vehicle models, there are also wheels that have closable fins. By covering the openings between the wheel spokes, the air turbulence along the wheel axle is significantly reduced, thus also lowering the CD value. The reduction of the CD value, and thus of the air resistance, results in lower energy demand and thus in a greater vehicle efficiency. However, this further development with closed-surface wheels does not offer the design possibilities of traditional vehicle wheels.

EP 3 153 328 B1 discloses and describes a turbine insert for a vehicle wheel, which is provided with two aerodynamic blades and which can be inserted into an opening in a wheel main body, between two adjacent wheel spokes.

Known from DE 10 2018 203 805 A1 is a vehicle wheel in which at least one interspace between the wheel spokes is at least partially covered by a cover element comprising a wing portion, the cover element being mountable onto the wheel from an outer side of the wheel.

DE 10 2011 102 680 A1 discloses a vehicle wheel having a hub cover provided with a display device.

The object of the present invention is to improve a generic cover element in such a way that it can be used more flexibly.

This object is achieved with the features of the independent claim.

A cover element is adapted for attaching to a vehicle wheel. The vehicle wheel has a wheel hub, a wheel rim provided with a rim base for receiving a tire, and a central body connecting the wheel hub to the wheel rim. The cover element is realized in the form of a circular disk in order to cover the central body. Such a cover element is characterized, according to the invention, in that the outer surface of the cover element, at least in regions, is provided with or formed by at least one bistable display element, preferably an e-paper display element, comprising a display to which electrical control signals can be applied via a control unit.

The cover element according to the invention forms a rim cover having an integrated controllable bistable display element, for example an e-paper display element. Any rim designs that are or can be stored in a memory of the control unit can be rendered on this e-paper display element. In addition, the e-paper display element can be used to present functional items of information. Electrical energy is only required for changing the image, such that a small battery or an external energy source with, for example, inductive energy transmission is sufficient for changing the display.

A round e-paper display element is used as the basis for the rim cover. This works with reflection instead of with active illumination, and is therefore also permitted in road traffic. The control of the e-paper display element may be effected both via a control computer provided in the e-paper display element and via an external control computer. The control computer transfers the image data of the images selected by the user onto the e-paper display element. This transmission of data is effected only in the case of a dynamic display or a change of image or a refreshing of the image. The image information and associated data are transferred, for example wirelessly, from the vehicle to the control computer. The actual image files may be physically stored in a memory on the vehicle, or also on an external server.

Further preferred and advantageous design features of the cover element according to the invention are provided by the dependent claims.

Preferably, the display of the at least one e-paper display element covers the outer surface, at least in regions.

It is also advantageous if the at least one e-paper display element is configured to represent color displays on the display device.

In a preferred embodiment of the invention, which can be combined with other embodiments, the control unit is equipped with or connected to a selecting or input device, by means of which a user can select or set colors and/or patterns to be displayed on the display of the e-paper display element, and the control unit is configured to thereupon generate corresponding display signals and transmit them to the display.

In a further preferred embodiment of the invention, which can also be combined with other embodiments, the control unit is provided with a signal input via which it receives signals representing a current operating state of the vehicle or servicing information, and the control unit is configured so that it displays a predefined display on the display device of the e-paper display element in dependence on the signals representing a current operating state of the vehicle or servicing information, and for this purpose generates corresponding display signals and transmits them to the e-paper display element.

The invention also relates to a vehicle wheel that has a wheel hub, a wheel rim provided with a rim base for receiving a tire, and a central body connecting the wheel hub to the wheel rim, wherein the wheel hub, the wheel rim and the central body form a vehicle wheel body, and that has at least one cover element, wherein the cover element is realized in the form of a circular disk and covers the central body.

It is advantageous in this case if the cover element is connected to the vehicle wheel body in a rotationally fixed manner. This allows a rim design represented on the display, for example a virtual wheel spoke arrangement, to rotate synchronously with the wheel without the need to constantly reconstruct the displayed image.

Alternatively, the cover element may be connected to the vehicle wheel body so as to be rotatable, relative to the latter, about the axis of rotation of the vehicle wheel. This variant makes it possible to display messages (for example warning messages or servicing instructions) on the display, which can also be read from the outside when the vehicle is in motion, without this display having to be virtually rotated against the wheel rotation by the control computer and thus having to be constantly reconstructed with an expenditure of energy.

Finally, the invention also relates to a motor vehicle having at least one such vehicle wheel.

For use, basically three different situations are distinguished: the road situation, the hazard situation and the servicing situation. In conventional road use, drivers can select their rim design via the on-board computer or via an alternative input device before starting the journey. This is then transmitted to the display of the e-paper display element. The rim design may be provided, for example, in a standard version by the wheel manufacturer or vehicle manufacturer at the time of purchase. Further rim designs may be subsequently purchased and uploaded, or rim designs already stored in the vehicle may be enabled. Individual coloring and pattern design by the user is also conceivable. In this way, vehicle users can always decide anew which rim design they wish to use when driving.

In a hazard situation, the vehicle can issue warning signals or items of information via the display of the e-paper display element on the rim. Warning signals in this case may be generated via a dynamic change of image. Conceivable items of information in the case of electrically driven vehicles would be, for example, feedback on the battery status (protected or unprotected). This enables persons outside the vehicle to assess whether they may approach the vehicle or not. The display of further items of information is of course also conceivable.

In the servicing state, vehicle data can be displayed on the display of the e-paper display element. A possible scenario is, for example, checking of the tire pressure at the service station. As soon as the vehicle stops and the tire valve cap is removed, the items of information (for example, the actual and reference tire pressure) are displayed.

The use of an e-paper display element offers almost limitless application possibilities, which can be easily expanded as the entire vehicle evolves. Content and functions can be added by software at low cost.

Advantages of the rim design according to the invention with the bistable display element, for example the e-paper display element, are the integration of non-actively illuminated display elements with possible approval for road use, a low-cost and variable design of the rim design, user ability to customize the rim design, increased safety due to external communication during a hazard situation, and the possibility of displaying functional items of vehicle information.

Preferred exemplary embodiments of the invention with additional design details and further advantages are described and explained in more detail below with reference to the accompanying drawing.

### BRIEF DESCRIPTION OF THE DRAWINGS

FIG. 1 is a side view of the rear left part of a motor vehicle equipped with a vehicle wheel, realized according to an embodiment of the invention, having a virtually represented rim design;

FIG. 2 is a side view of the vehicle wheel from FIG. 1 with the cover element represented in partial section;

FIG. 3 is a schematic cross-section through an e-paper display element; and

FIG. 4 shows the side view of the vehicle from FIG. 1 with a servicing display represented on the vehicle wheel.

### DETAILED DESCRIPTION OF THE DRAWINGS

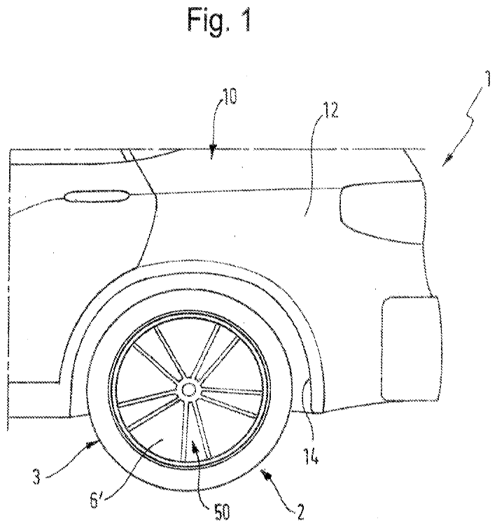

FIG. 1 shows the rear left side of a motor vehicle 1 having a vehicle body 10, which has a rear left wheel arch 14 in a rear left fender 12. The wheel arch 14 accommodates a left rear vehicle wheel 2, which is rotatably mounted in a conventional manner on a structure of the motor vehicle 1.

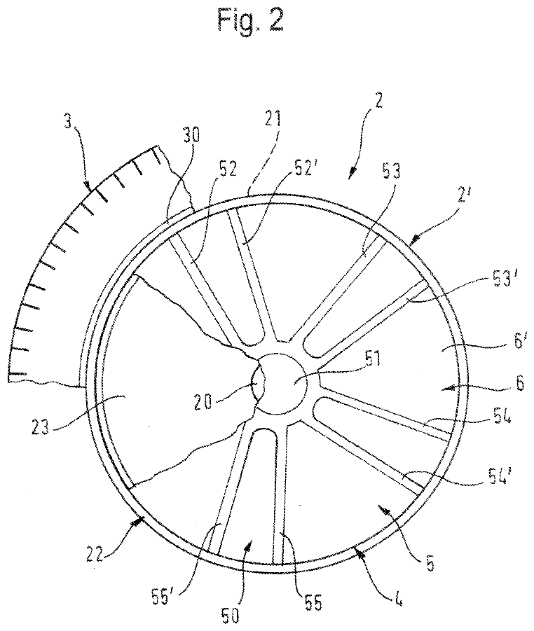

The vehicle wheel 2 provided with a tire 3 is represented in detail in FIG. 2.

The vehicle wheel 2 has a wheel hub 20, a wheel rim 22 and a central body 23, for example realized as a wheel disk, which connects the wheel hub 20 to the wheel rim 22. On its radially outer side the wheel rim 22 is provided, in a conventional manner, with a rim base 21, in which the tire 3 is accommodated via its tire beads 30.

A cover element 4 in the form of a circular disk is fitted from the outside of the vehicle onto the metallic vehicle wheel body 2′, which comprises the wheel hub 20, the wheel rim 22 and the central body 23. The cover element 4 covers over the wheel hub 20 and the central body 23. Toward the outside of the vehicle, therefore, the cover element 4 forms a closed wheel disk face 5 radially inside the wheel rim 22. However, the invention is not limited to such a closed wheel disk face 5, but through-openings (not represented) may also be provided in the wheel disk face 5 and the central body 23 to allow air to flow between the outside of the wheel and the inside of the wheel, for example for the purpose of cooling brakes or wheel hub motors.

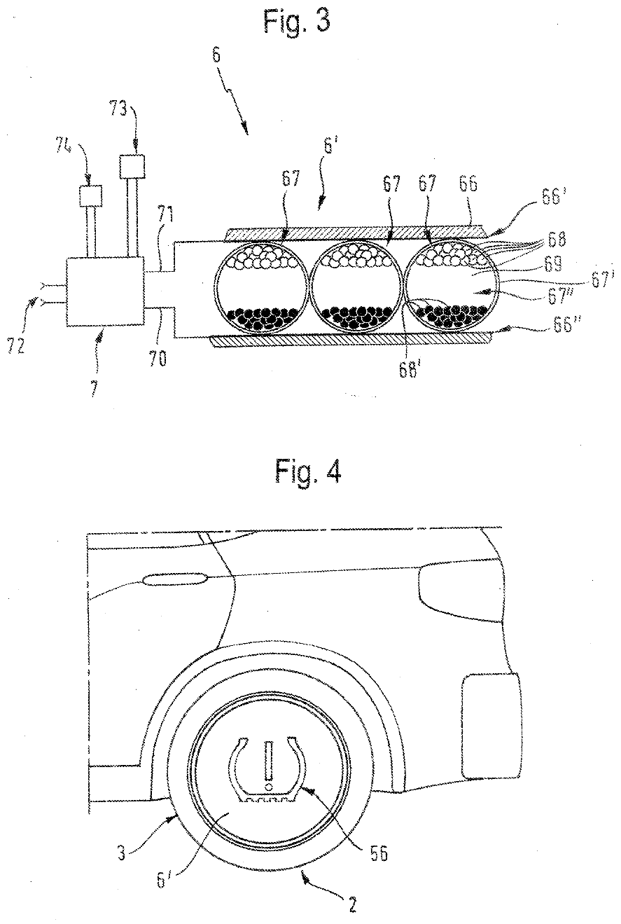

The outer surface of the cover element 4 that faces away from the vehicle is provided with at least one e-paper display element 6, which is provided with a display device 6′, facing toward the outside of the vehicle, which is explained in more detail in connection with FIG. 3.

As can be seen in FIG. 3, the display device 6′ has a transparent or translucent upper display window 66, behind which there are a multiplicity of display spheres 67 in the form of microcapsules. The display window 66 simultaneously forms a first flat (upper) electrode 66′. A second flat (lower) electrode 66″ is provided on the rear side of the e-paper display element 6, behind the display spheres 67. Each of the display spheres 67 has a transparent housing wall 67′ enclosing an interior space 67″ of the display sphere 67. The interior space 67″ contains a plurality of first pigments 68 of a first color (in this case, white) and a plurality of second pigments 68′ of a second color (in this case, black) surrounded by a transparent fluid 69, the black pigments 68′ typically being positively charged and the white pigments 68 being negatively charged.

Upon activation of a positive or negative electric field by application of a voltage to the electrodes 66′, 66″, the black pigments 68′ and the white pigments 68 move to the respective opposite electrodes 66′, 66″. The quantity of pigment particles moving to the upper (transparent) electrode 66′ becomes visible to the viewer as a black or white dot, respectively, in the display window 66.

This simple e-paper display element 6, shown by way of example in FIG. 3, is only capable of displaying black and white representations. Colors can also be displayed by use of a plurality of different display spheres containing colored pigments in place of the white pigments 68.

The display device 6′ of the display element 6 can be supplied with electrical control signals via a control unit 7. For this purpose, the display device 6′ is functionally connected to the control unit 7 for the purpose of signal transmission. In FIG. 3, this connection is represented by electrical signal lines 70, 71, which is the case if the control unit 7 is provided on the display element 6. Alternatively, however, this connection may also be wireless.

The control unit 7 is equipped with, or preferably wirelessly connected to, a selecting or input device 73, as well as to a data storage 74. By means of the selecting and input device 73, a user can select or set the colors and/or patterns to be displayed on the display 6′, whereupon the control unit 7 generates corresponding display signals, for example from values stored in the data storage 74, and transmits them to the display 6′, and the display 6′ displays the selected color and/or graphical pattern.

In the example of FIG. 1, the control unit 7 effects on the display device 6′ the representation of a wheel rim design 50 having a virtual wheel hub 51 displayed in the center of the display device 6′, coaxially with the physically present wheel hub 20, and having virtual wheel spokes 52, 52′, 53, 53′, 54, 54′, 55, 55′ extending radially from the virtual wheel hub 51 to the wheel rim 22. Since the display device 6′ is mounted to the wheel in a fixed manner, it rotates concomitantly with the vehicle wheel 2, and the virtual wheel rim design 50 rotates with the vehicle wheel 2.

In the representation of FIG. 4, the control unit 7 receives operating data of the vehicle via a signal input 72, for example from a control device of the vehicle, and thereupon generates display signals, which it transmits to the display device 6′ and which cause a servicing display 56, in this case, by way of example, in the form of a warning symbol for the tire pressure, to be represented on the display device 6′.

The invention is not limited to the above exemplary embodiment, which merely serves to provide a general explanation of the core concept of the invention. Rather, within the scope of protection, the device according to the invention may also assume forms of embodiment other than those described above. In this regard, the device may in particular have features that are a combination of the respective individual features of the claims.

Reference signs in the claims, the description and the drawings serve only for a better understanding of the invention and are not intended to limit the scope of protection.

### LIST OF REFERENCES

1 motor vehicle
2 vehicle wheel
2′ vehicle wheel body
3 tire
4 cover element
5 wheel disk face
6 e-paper display element
6′ display device (display)
7 control unit
10 vehicle body
12 fender
14 wheel arch
20 wheel hub
21 rim base
22 wheel rim
23 wheel disk
30 tire bead
50 virtual rim design
51 virtual wheel hub
52 virtual wheel spoke
52′ virtual wheel spoke
53 virtual wheel spoke
53′ virtual wheel spoke
54 virtual wheel spoke
54′ virtual wheel spoke
55 virtual wheel spoke
55′ virtual wheel spoke
56 servicing display
66 display window
66′ electrode
66″ electrode
67 display sphere
67′ housing wall
67″ interior space of the display sphere
68 first pigment
68′ second pigment
69 fluid
70 signal line
71 signal line
73 input means
74 data storage

1.-9. (canceled)

10. A cover element adapted for attaching to a vehicle wheel having a wheel hub, a wheel rim provided with a rim base for receiving a tire, and a central body connecting the wheel hub to the wheel rim, the cover element comprising:
a circular disk configured to cover the central body, wherein
an outer surface of the cover element, at least in regions, is provided with or formed by at least one bistable display element comprising a display device to which electrical control signals are applied via a control unit.

11. The cover element according to claim 10, wherein
the bistable display element is an e-paper display element.

12. The cover element according to claim 11, wherein
the display device of the e-paper display element covers the outer surface, at least in regions.

13. The cover element according to claim 11, wherein
the e-paper display element is configured to represent color displays on the display device.

14. The cover element according to claim 11, wherein
the control unit is equipped with or connected to a selecting or input device, by which a user can select or set colors and/or patterns to be displayed on the display device of the e-paper display element, and
the control unit is configured to generate corresponding display signals and transmit the display signals to the display device.

15. The cover element according to claim 11, wherein
the control unit is provided with a signal input via which the control unit receives signals representing a current operating state of the vehicle or servicing information, and
the control unit is configured so as to display a predefined display on the display device of the e-paper display element in dependence on the signals representing a current operating state of the vehicle or servicing information, and for this purpose generates corresponding display signals and transmits them to the e-paper display element.

16. A vehicle wheel, comprising:
a vehicle wheel body comprising a wheel hub, a wheel rim provided with a rim base for receiving a tire, and a central body connecting the wheel hub to the wheel rim;
at least one cover element, wherein the cover element is a circular disk and covers the central body, and
wherein an outer surface of the cover element, at least in regions, is provided with or formed by at least one bistable display element comprising a display device to which electrical control signals are applied via a control unit.

17. The vehicle wheel according to claim 16, wherein
the bistable display element is an e-paper display element.

18. The vehicle wheel according to claim 16, wherein
the cover element is connected to the vehicle wheel body in a rotationally fixed manner.

19. The vehicle wheel according to claim 16, wherein
the cover element is connected to the vehicle wheel body so as to be rotatable, relative to the latter, about an axis of rotation of the vehicle wheel.

20. A motor vehicle comprising at least one vehicle wheel according to claim 16.
